(19) United States
(12) Patent Application Publication
(10) Pub. No.: US 2026/0147651 A1
(43) Pub. Date: May 28, 2026

(54) SYSTEM AND METHODS FOR PROVIDING FAILOVER READINESS PREDICTION

(71) Applicant: THE BANK OF NEW YORK MELLON, New York, NY (US)

(72) Inventors: Venkata R. SUDA, New York, NY (US); Anil Kiran VELLALA, New York, NY (US)

(21) Appl. No.: 18/963,056

(22) Filed: Nov. 27, 2024

(51) Int. Cl. G06F 11/20; G06F 18/2325; G06F 18/24

(52) U.S. Cl. CPC G06F 11/008; G06F 11/2069; G06F 18/2325; G06F 18/24; G06N 20/00; G06Q 10/04; G06F 11/2023

(57) ABSTRACT

Systems and methods for providing failover readiness prediction, comprise: during a training stage: selecting a first set of data from a database of historical failover data based at least in part on feature importance within the historical failover data; label encoding the first set of data; tokenizing the first set of data; converting the first set of data into a set of dense vector representations; and training a classification model using the set of dense vector representations; during a predication stage: receiving a request to predict a failover outcome for a given failover process; assessing a status of concurrent system conditions; and predicting at least one of a success probability of the failover process, or an expected time for at least one of a plurality of steps in the failover process, based at least in part on the classification model and the status of the concurrent system conditions.

### TECHNICAL FIELD

The present disclosure relates generally to application instance migration, and more particularly to systems and methods for predicting failover readiness.

### BACKGROUND

Applications that must be highly reliable and resilient are generally configured to have redundant instances. These instances are typically spread across locations to allow for a degree of geographical isolation in the event a disaster or unexpected event occurs in a particular geography. During an actual disaster event, or during an event to test an application's ability to handle a disaster event, switching the application's primary instance (also known as “failover”) typically involves a number of configuration changes and technology activities. These activities often have to be well coordinated between teams that own the application and their teams that manage the infrastructure components and services.

Computing applications interact with various data repositories, such as servers, databases, datacenters, etc., during the course of their operation. Some computing applications may also be hosted on remote computing elements. In the event that such remote data repositories and computing elements are unavailable (i.e., offline, damaged, etc.), such as due to a datacenter failure, applications can be switched to run at or on alternative data repositories and/or computing elements in a “failover” operation. Switching an application from a first (or primary) instance or location to a second (or secondary) instance or location in a failover can involve changing one or more paths, servers, databases, configurations, technologies, etc., for an application and initializing one or more instances of the application in the secondary location. Application reliability, resiliency, and continuity is thereby correlated to failover reliability, robustness, and speed.

A number of applications and services may be required to have certain levels of redundancy, e.g., based on specific recovery time objectives for specific applications and services. Often, the process by which applications exercise redundancy capabilities (i.e., failover) requires (1) primarily manual activity; (2) periodic (e.g., monthly, quarterly, yearly, etc.) tests to confirm readiness to failover in the event of an actual disaster, orchestration of which is often manually intensive with no systematic visibility into the state of procedural execution as steps are initiated, completed, or fail); and (3) fully manual documentation of redundancy procedures, which is subject to quickly becoming outdated as services evolve and infrastructure naturally is maintained and scaled.

Due to the complexity of monitoring and implementing failover in the event of an application or service failure, there are currently no reliable systems or methods for predicting whether an application failover will be successful. Furthermore, there are currently no reliable systems or methods for predicting the time taken by each step in a workflow to complete a failover. During application recovery, whether it is a failover scenario, a “stay” situation, or disaster recovery, there are numerous challenges that can lead to unexpected process failures, which often prove to be costly and require significant resources. The time-sensitive nature of these recoveries exacerbates the problem, as delays or failures can have serious operational and financial consequences. A key issue is the inability to reliably predict the success of an application failover or accurately estimate the time required for each step in the workflow to complete. This unpredictability adds layers of complexity to the recovery process. One common reason for failover failure stems from incorrect or misconfigured settings in the recovery playbook, where even small errors can derail the entire recovery process. Another contributing factor is the lack of a structured mechanism to incorporate lessons learned from previous failures, leading to repeated mistakes and missed opportunities for process improvement. Insufficient testing of recovery processes leaves many organizations unprepared for real-world scenarios, as they fail to account for all possible failure modes and recovery environments.

Furthermore, inadequate employee training exacerbates recovery challenges, as staff may lack the necessary skills or familiarity with the recovery procedures, leading to missteps during execution. Procedural mismatches between the recovery plan and the documented playbook can also occur, where the written steps no longer align with actual system configurations or current best practices, creating confusion during execution. Unexpected outages in the target platforms add another layer of unpredictability, as external factors such as infrastructure failures or network issues can prevent successful failovers even when internal procedures are followed correctly. Additionally, organizations may struggle to meet their Recovery Point Objective (RPO) and Recovery Time Objective (RTO), two critical benchmarks that define the acceptable limits of data loss and the time allowed for recovery. Failing to meet these objectives can lead to prolonged downtime and significant data loss, further compounding the impact of the initial failure. Other potential issues that may arise include poor communication between teams during recovery efforts, incomplete or outdated documentation, and the lack of automated monitoring tools to detect and address issues in real-time. All of these factors combine to make application recovery a high-risk, resource-intensive process with substantial room for error.

What is needed, therefore, is a solution which addresses these and other limitations of present failover readiness prediction mechanisms.

### SUMMARY

The following is a non-exhaustive listing of some aspects of the present techniques. These and other aspects are described in the following disclosure.

In some aspects, the techniques described herein relate to a method for providing failover readiness prediction, including: during a training stage: selecting, by a processor, a first set of data from a database of historical failover data based at least in part on feature importance within the historical failover data; label encoding, by the processor, the first set of data; tokenizing, by the processor, the first set of data; converting, by the processor, the first set of data into a set of dense vector representations; and training, by the processor, a classification model using the set of dense vector representations; during a predication stage: receiving, by the processor, a request to predict a failover outcome for a given failover process; assessing, by the processor, a status of concurrent system conditions; and predicting, by the processor, at least one of a success probability of the failover process, or an expected time for at least one of a plurality of steps in the failover process, based at least in part on the classification model and the status of the concurrent system conditions.

In some aspects, the techniques described herein relate to a method, wherein the historical failover data includes data relating to failed failovers and successful failovers.

In some aspects, the techniques described herein relate to a method, wherein the selected first set of data includes balanced data reflecting both the failed failovers and the successful failovers.

In some aspects, the techniques described herein relate to a method, wherein the feature importance is determined by implementing at least one of a correlation matrix or a heat map.

In some aspects, the techniques described herein relate to a method, wherein the classification model is a random forest classifier model.

In some aspects, the techniques described herein relate to a method, wherein predicting the success probability of the failover process includes predicting one or more of the success probability of at least one specific step action of a plurality of step actions in the failover process, or an overall success probability of the failover process.

In some aspects, the techniques described herein relate to a method, further including predicting at least one of an average time per step of the plurality of steps in the failover process or an overall time for the failover process.

In some aspects, the techniques described herein relate to a system for providing failover readiness prediction, including: a computer system including one or more processors programmed with computer program instructions which, when executed, cause the computer system to: during a training stage: select a first set of data from a database of historical failover data based at least in part on feature importance within the historical failover data; label encode the first set of data; tokenize the first set of data; convert the first set of data into a set of dense vector representations; and train a classification model using the set of dense vector representations; during a predication stage: receive a request to predict a failover outcome for a given failover process; assess a status of concurrent system conditions; and predict at least one of a success probability of the failover process, or an expected time for at least one of a plurality of steps in the failover process, based at least in part on the classification model and the status of the concurrent system conditions.

In some aspects, the techniques described herein relate to a system, wherein the historical failover data includes data relating to failed failovers and successful failovers.

In some aspects, the techniques described herein relate to a system, wherein the selected first set of data includes balanced data reflecting both the failed failovers and the successful failovers.

In some aspects, the techniques described herein relate to a system, wherein the feature importance is determined by implementing at least one of a correlation matrix or a heat map.

In some aspects, the techniques described herein relate to a system, wherein the classification model is a random forest classifier model.

In some aspects, the techniques described herein relate to a system, wherein predicting the success probability of the failover process includes predicting one or more of the success probability of at least one specific step action of a plurality of step actions in the failover process, or an overall success probability of the failover process.

In some aspects, the techniques described herein relate to a system, further configured to predict at least one of an average time per step of the plurality of steps in the failover process or an overall time for the failover process.

In some aspects, the techniques described herein relate to a non-transitory computer-readable media including instructions that, when executed by one or more processors, cause operations including: during a training stage: selecting a first set of data from a database of historical failover data based at least in part on feature importance within the historical failover data; label encoding the first set of data; tokenizing the first set of data; converting the first set of data into a set of dense vector representations; and training a classification model using the set of dense vector representations; during a predication stage: receiving a request to predict a failover outcome for a given failover process; assessing a status of concurrent system conditions; and predicting at least one of a success probability of the failover process, or an expected time for at least one of a plurality of steps in the failover process, based at least in part on the classification model and the status of the concurrent system conditions.

In some aspects, the techniques described herein relate to a non-transitory computer-readable media, wherein the historical failover data includes data relating to failed failovers and successful failovers.

In some aspects, the techniques described herein relate to a non-transitory computer-readable media, wherein the selected first set of data includes balanced data reflecting both the failed failovers and the successful failovers.

In some aspects, the techniques described herein relate to a non-transitory computer-readable media, wherein the feature importance is determined by implementing at least one of a correlation matrix or a heat map.

In some aspects, the techniques described herein relate to a non-transitory computer-readable media, wherein the classification model is a random forest classifier model.

In some aspects, the techniques described herein relate to a non-transitory computer-readable media, wherein predicting the success probability of the failover process includes predicting one or more of the success probability of at least one specific step action of a plurality of step actions in the failover process, or an overall success probability of the failover process; and further including predicting at least one of an average time per step of the plurality of steps in the failover process or an overall time for the failover process.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

Features, aspects, and embodiments of the inventions are described in conjunction with the attached drawings, in which:

FIG. 1 depicts an illustrative system for providing failover readiness prediction, in accordance with at least one embodiment;

FIG. 2 depicts an example method for providing failover readiness prediction, in accordance with at least one embodiment;

FIG. 3 depicts a user interface of a failover readiness predictor application, shown according to at least one embodiment; and

FIG. 4 is a schematic of a computing system, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of computing systems. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

While some of the embodiments below are described in relation to failover readiness prediction, it will be understood that the systems and methods described herein may apply equally to prediction readiness of other applications, e.g., switching production databases, alternating between production and development databases, server maintenance support, to name just a few. Thus, the following descriptions should not be seen to limit the system, methods, and machine-readable medium described herein to any particular type of readiness prediction.

For various reasons an application (in one or more instances) may be discontinued (temporarily or permanently) in a current (or primary) datacenter. As many applications are vital for business purposes—including client needs, documentation, regulatory requirements—a discontinued application may then be migrated to another datacenter or otherwise initialized in a secondary or backup location. Failover automation, and automation of other migration processes, allows greater process control during switching of the application instances. Failover, as understood herein, may generally refer to systems and methods of protecting computer systems and/or programs from failure, in which standby systems and/or programs are enabled to automatically take over when the main systems and/or programs fail. However, as noted above, predicting the success or failure of a failover system is complicated.

During the process of application recovery—whether in the context of a failover or a full-scale disaster recovery—there is a potential for unexpected process failures. These failures can occur unpredictably and often exacerbate the challenges associated with time-sensitive recovery operations. Given the urgency typically involved in restoring application functionality, such failures can significantly increase both the cost and the demand for resources.

Moreover, presently available systems lack a reliable mechanism to accurately predict the likelihood of a successful failover, or the amount of time required to complete each step or phase of a failover recovery. This unpredictability adds further complexity to the recovery process, as there is no assurance that an application will resume its intended operations without disruption. Consequently, the absence of a dependable failover prediction method elevates the risks and operational burdens involved in recovery efforts.

The innovative failover readiness predictor described herein addresses several limitations of traditional systems and methods for predicting the success of application failovers by incorporating advanced and data-driven techniques. First, in some embodiments, by assessing the accuracy of recovery predictions, the systems and methods described herein enhance system reliability, providing a more robust foundation for decision-making during critical recovery processes. This improvement mitigates the unpredictability of prior systems, where success or failure of recovery was often difficult to foresee, leading to operational risks.

Second, in some embodiments, the predictor focuses on optimizing resource allocation by forecasting recovery success rates. During contingencies, resources may be efficiently distributed based on the predicted likelihood of successful recovery, which may reduce waste and improve the overall efficiency of the recovery process.

Third, in some embodiments, the systems and methods described herein quantify recovery preparedness, giving organizations a clear metric to gauge how well they are positioned to handle failures without interrupting operations. This aspect addresses the uncertainty of preparedness in previous methods, which often lacked a quantifiable measure, leaving organizations vulnerable to unexpected downtime.

Fourth, in some embodiments, the systems and methods described herein may use historical data to refine the prediction models. By learning from past recovery events, the system may continuously improve the accuracy and effectiveness of its predictions. This data-driven approach surpasses the static nature of prior methods, which did fully not leverage historical trends to enhance future readiness.

Finally, in some embodiments, systems and methods described herein may implement AI-driven recovery readiness predictor which enable real-time risk assessment, e.g., based at least in part on classification models and/or the status of concurrent system conditions, allowing organizations to proactively manage potential failovers. This real-time or near-real-time capability offers a significant improvement over earlier systems that relied on manual or delayed evaluations, providing organizations with a dynamic, adaptive solution for failover prediction and response.

These and other embodiments may be further explained with reference to the figures described herein.

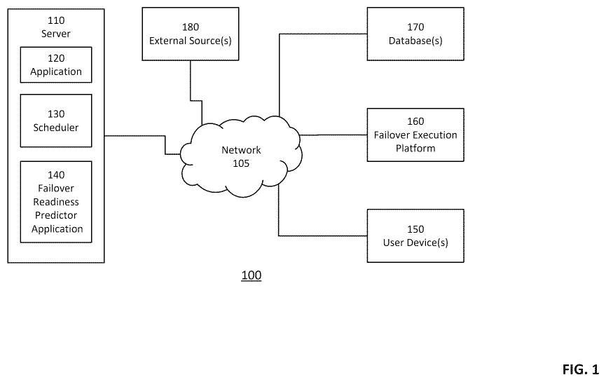

FIG. 1 depicts an illustrative system 100 for providing failover readiness prediction, in accordance with at least one embodiment. FIG. 1 illustrates a functional block diagram of an embodiment of a failover readiness prediction system 100 within which at least some of the disclosed techniques may be implemented. The failover readiness prediction system 100 may be established or implemented to permit the prediction of a success probability of a failover process and/or an expected time for at least one of a plurality of steps in the failover process, as described herein.

In some embodiments, various devices and applications described herein may be configured to communicate via network 105. In some embodiments, computing devices and servers described herein may communicate over network 105, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 may be any combination of the above, which may be a combination of private and public networks.

In some embodiments, each of the elements of failover readiness prediction system 100 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an entity may execute, on a server or other computing system, e.g., server 110, one or more applications, such as application 120.

In some embodiments, application 120, which may include one or more application instances, may interact with one or more datacenter data repositories or services. The application 120 may interact with one or more database services, storage services, network services, computational services, container services, messaging services, etc. The list of services provided is exemplary only and should not be construed as a closed list of possible services. In some embodiments, the identity of the application 120 may determine with which services and/or which datacenters the application 120 interacts. In some embodiments, a list of application interactions may be maintained, such as a list maintained for performing a manual, automated, or semi-automated failover. In other embodiments, a program (such as a program which tracks and identifies network traffic) may be used to determine with which datacenter services the application 120 interacts.

In some embodiments, application (and other programs) may interact with users, other applications, various datacenter and/or cloud storage, databases, etc. Applications may run based on databases stored remotely, which may be accessed and/or managed through communication between the application and a SQL Server, Oracle DB, Mongo DB, PostgreSQL, UBD (or other object-oriented relational database management system (OORDBMS)), etc. Applications may be hosted, such as by a proprietary On-Premise application Hosting Platform or a commercially available Cloud Hosting Platform or another container engine or container orchestration system, as various individual instances. Applications may leverage datacenter storage based on Symmetric Remote Data Facility (SRDF), Network Attached Storage (NAS), etc. Applications may also exchange messages, such as through Messaging Queue (MQ) or another appropriate messaging platform. Applications may operate on Windows, Linux, Apple, etc. operating systems.

Applications may exchange information via one or more Application Programming Interface (API), e.g., over network 105. Applications may interact with application servers such as Microsoft Internet Information Services (IIS), or other web servers. Applications may be accessed remotely, which instances operate at a datacenter, such as via Citrix or Virtual Private Network (VPN) or other clients. Applications traffic and loads may be balanced between instances, servers, datacenters, etc. by Global Service Load Balancing (GSL) or other load balancing programs. Cluster services may be provided by Veritas Cluster Server (VCS) or other cluster management programs. Applications may include automated tasks, such as, for example, those programmed in Ansible. Applications may operate in any appropriate programming language and data exchange configuration.

In some embodiments, server 110 may further include scheduler 130. As understood herein, a scheduler is an application or other software responsible for organizing, prioritizing, and managing the allocation of resources—whether personnel, equipment, or time—across various tasks, projects, and day-to-day operations. It serves as a central mechanism for planning and optimizing workflows, such that resources are assigned efficiently to meet both short-term and long-term objectives. By coordinating activities, a scheduler allows a company to handle regular operational functions, such as routine maintenance, staffing, and production, while also remaining agile enough to address immediate customer needs.

In project management, a scheduler facilitates resource allocation in a way that aligns with project deadlines and priorities, minimizing downtime and avoiding bottlenecks. Furthermore, the scheduler may dynamically adjust to changes in demand, allowing a company to quickly respond to unexpected events or shifts in customer requirements without compromising ongoing work. This capability enhances the company's ability to maintain productivity, meet customer expectations, and optimize the use of its resources across all functions.

By way of example, in a banking environment, a “Run-the-Bank” (RTB) scheduler may be implemented to facilitate the seamless operation of day-to-day banking services and to manage critical processes. For instance, the RTB scheduler may coordinate and automate the timing and execution of routine tasks such as transaction processing, clearing payments, account reconciliations, and daily balance updates.

Additionally, the RTB scheduler may prioritize urgent tasks, such as handling a sudden influx of customer requests or reacting to unexpected events, like a system failure. It may shift the timing of non-critical processes to accommodate time-sensitive customer transactions, such that key services are always operational without compromising the bank's performance or regulatory obligations. By optimizing task execution, a bank's RTB scheduler helps maintain the integrity of daily operations, minimizes delays in customer services, and helps efficient resource usage across all systems and departments. In some embodiments, scheduler 130 may be further configured to schedule the execution, implementation, and/or updating of failover readiness predictor application 140, described in detail herein.

In some embodiments, failover readiness predictor application 140 may be configured to execute various steps as described in detail herein, to predict the success of an application failover and/or estimate the time required for each step in the workflow to complete the failover, as described in detail herein.

It should be noted that while application 120, scheduler 130, and failover readiness predictor application 140 are shown in FIG. 1 as residing on server 110, in other embodiments, these and other elements may reside elsewhere in system 100, and server 110 may be configured to interact and/or execute these elements remotely, e.g., via network 105.

In some embodiments, one or more users may execute failover readiness predictor application 140. For example, an entity may provide users access to failover readiness predictor application 140 on or via various user devices, e.g., user devices 150. In some embodiments, users may access a web-based version of failover readiness predictor application 140, e.g., hosted by a computing system managed by or provisioned by the entity, or which communicates with such a computing system via an application programming interface (API). Accordingly, one or more of the devices/systems/elements depicted herein may communicate with one another via messages transmitted over network 105, such as the Internet and/or various other local area networks. For example, one or more applications may communicate via messages transmitted over network 105.

In some example embodiments, server 110 may include, host, or otherwise execute failover readiness predictor application 140. In some embodiments, failover readiness predictor application 140 may be a user facing application with which a user interfaces to access various aspects of the systems and methods described herein. In some embodiments, failover readiness predictor application 140 may include a user interface through which a user may interact with failover readiness prediction system 100 via various user devices, e.g., devices 150. For example, one or more users may use one or more user devices 150, e.g., to input data (e.g., text or other inputs), or to implement a failover prediction, e.g., via a button on a user interface. Furthermore, in some embodiments, failover readiness predictor application 140 may be configured to provide results and/or other visuals to a user via a user interface of user device 150.

In some embodiments, users may access user devices 150 to implement a failover process, e.g., via a failover execution platform, such as failover execution platform 160. As understood herein, failover execution platform 160 may be any platform configured to implement or enable execution of a failover recovery. An example failover execution platform is described in detail in U.S. application Ser. No. 17/679,879, (U.S. Pub. App. US20230267035A1), which is incorporated herein by reference in its entirety.

In some example embodiments, failover readiness predictor application 140 may be configured to coordinate with database(s) 170. Database 170 may be one or a collection of databases, configured to collect data relating to failover readiness prediction system 100 and/or elements thereof. For example, database 170 may store various data regarding network 105, server 110, application 120, scheduler 130, failover readiness predictor application 140, user device(s) 150, and/or failover execution platform 160. In particular, in some embodiments, database 170 may contain data used in predicting the success of an application failover and/or estimating the time required for one or more steps in the workflow to complete, including, e.g., historical failover data, concurrent system data (e.g., current usage), etc.

In some embodiments, external source(s) 180 may be any external source with which failover readiness predictor application 140 may be configured to interact, e.g., APIs, other organizations or databases, or even other separate systems within an organization, etc.

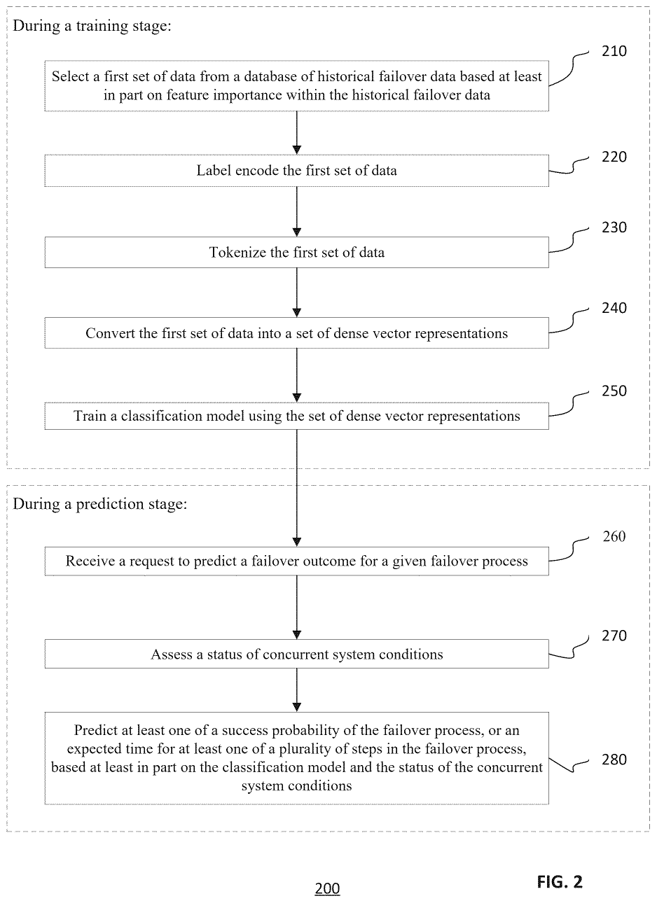

These and other features of failover readiness prediction system 100 will be further understood with reference to the failover readiness prediction method 200 of FIG. 2, herein.

FIG. 2 depicts an example method for providing failover readiness prediction, in accordance with at least one embodiment. In various embodiments, method 200 may be implemented by failover readiness prediction system 100, executing code in one or more processors therein. For example, in some embodiments, method 200 may be performed on a computer (e.g., computer system 600 of FIG. 6) having one or more processors (e.g., processor(s) 610 of FIG. 6) and memory (e.g., system memory 620 of FIG. 6), and one or more code sets, applications, programs, modules, and/or other software stored in the memory and executing in or executed by one or more of the processor(s). In some embodiments, method 200 may be separated in two primary stages, a training stage and a prediction stage. However, as explained herein, embodiments of the systems and methods described herein may include mechanisms for updating training data (e.g., retraining) during the prediction stage, and vice versa (e.g., generating predictions during the training stage). Accordingly, those skilled in the relevant art will understand that these two stages should not be viewed as limiting.

Method 200 begins, during a training stage, at step 210, when a processor (e.g., of server 110) is configured to select a first set of data from a database (e.g., database 170) of historical failover data based at least in part on feature importance within the historical failover data. In some embodiments, historical failover data may refer to past records and/or events related to system failovers and recoveries. This data may encompass various parameters and metrics that provide insight into how previous failovers occurred, the steps involved, and the outcomes achieved. Historical failover data may be used in building models that predict failover readiness, as it allows for the identification of patterns and trends that can inform future failover events.

In some embodiments, different types of historical failover data may be used for this purpose. One type may include event logs, which capture detailed step-by-step actions taken during a failover, including system messages, alerts, and timestamps. Event logs may help identify the sequence of events and any errors that occurred during the failover process. Another type may involve failover outcomes, which provide information on whether the failover was successful or failed, the duration of downtime, and the time required for recovery. This data may help quantify the effectiveness of different failover strategies.

In some embodiments, performance metrics during failover events may be collected, such as system resource usage (e.g., CPU, memory, and network bandwidth) or application response times. These metrics can provide insights into how system performance is impacted during failover operations and may help predict whether future failovers will remain within acceptable performance thresholds and/or the time each step in a failover recover will take to complete.

Additionally, root cause analysis (RCA) reports may be another type of historical failover data. RCA reports document the underlying causes of failover failures or issues, identifying specific components or processes that contributed to the failure. This data may be used to improve prediction models by highlighting recurring failure points.

In some embodiments, historical configurations of the system at the time of failover may also be used. These configurations may include details about the hardware, software versions, and network architecture in place during the failover. Comparing past configurations with current setups may provide further predictive insights, allowing models to account for changes that may influence failover success. By incorporating these and/or other various types of historical failover data, in some embodiments, failover readiness prediction models may be refined to provide more accurate and reliable assessments of future failover events.

In some embodiments, data preprocessing may be performed on selected or received historical failover data, e.g., to confirm that the data is in a suitable format for use in machine learning models and/or to improve the accuracy and efficiency of those models. Preprocessing may involve several steps, such as handling missing or incomplete data, converting categorical features into numerical representations through methods like label encoding, normalizing or scaling continuous data to standardize ranges, and addressing class imbalances by balancing the dataset. These steps may be beneficial because raw historical data often contains inconsistencies, noise, or formats that are incompatible with machine learning algorithms. By cleaning, transforming, and/or organizing the data, preprocessing may enhance the model's ability to identify meaningful patterns and make accurate predictions about failover readiness.

In some embodiments, data fields within the historical failover data for training the model may be selected based on business logic and/or statistical methods, such as the correlation matrix. A correlation matrix may be a table that displays the correlation coefficients between variables, with values ranging, e.g., from −1 to 1. A high correlation between two variables indicates that when one variable changes, the other tends to change in a specific direction. Correlation coefficients close to 0 suggest a weak or no linear relationship. In some embodiments, heatmaps may be used to visually represent these correlations, e.g., through the use of colors. In some embodiments, feature importance may be used to narrow the dataset to a subset, e.g., a subset of columns extracted from the database.

In some embodiments, feature importance refers to a technique used to determine the contribution of each feature (or variable) in a dataset to the predictions made by a machine learning model. It helps identify which features have the most significant impact on the model's outcomes, guiding the selection of relevant data to improve model performance. Feature importance can be calculated using various methods, such as statistical metrics, decision tree-based models, or algorithms like random forests and gradient boosting. Features with higher importance scores are considered more influential in the model's predictions.

Feature importance may be applied to narrow down historical failover data to a subset of columns that contribute most to predicting failover readiness. In some embodiments, historical failover data includes a wide range of features, such as system logs, performance metrics, configurations, and failover outcomes. Processing all these features can be computationally intensive, and many of them may have little relevance to the model's predictive capabilities. By analyzing the importance of each feature, the dataset can be streamlined to focus on the most impactful columns.

For example, feature importance analysis may reveal that specific columns such as, e.g., App Mnemonic, Failover Mode, Action Type, Workflow Version, Step Status, Elapsed Time, From Datacenter, and/or To Datacenter have a strong influence on predicting successful failover outcomes. These columns may show consistent patterns or correlations with failover success or failure, making them key indicators in the model. Conversely, features with low importance, such as less relevant system configurations or infrequently used parameters, may contribute little to the predictions and can be excluded from the dataset.

In some embodiments, narrowing the dataset to focus on high-importance columns may improve the model's efficiency by reducing noise and unnecessary complexity. This approach may enhance the accuracy and performance of the model, enabling it to better predict failover readiness based on the most relevant features, while optimizing computational resources.

In order to have balanced representation, in some embodiments, the dataset may be balanced to include scenarios for both successful and failed steps. This balancing may be useful because, in some embodiments, there may be very few failed items, and without balancing, the model may become biased towards successful workflows. To address this, in various embodiments, some or all possible scenarios for different applications may be included, such that both success and failure cases are represented.

At step 220, in some embodiments, the processor may be configured to perform label encoding on the first set of data, e.g., transforming categorical data fields into numerical representations. Label encoding is a preprocessing technique used to convert categorical data-features that have discrete categories or labels—into numerical values, which are used for machine learning models that can only process numerical inputs. This technique assigns a unique integer to each category within a column, thereby transforming text-based categories into numerical counterparts.

In some embodiments, label encoding may be applied to specific features such as App Mnemonic, Failover Mode, Action Type, etc., which represent non-numeric values in the dataset. For example, in the case of the Failover Mode feature, different failover modes (e.g., “automatic,” “manual,” “semi-automatic”) may be assigned numerical labels such as 0, 1, and 2, respectively. Similarly, App Mnemonic, which may represent various application codes, and Action Type, which may refer to different operational actions (e.g., “start,” “stop,” “restart”), may be encoded into corresponding numerical values.

In some embodiments, the label-encoded values may be stored in a dictionary format, where each unique category is mapped to its corresponding integer value as key-value pairs. For example, the dictionary for Failover Mode might store the mapping {“automatic”: 0, “manual”: 1, “semi-automatic”: 2}. These key-value pairs may then be saved into files, such as Python files, to be used consistently across both the training and testing phases of the machine learning model. By saving the encoded mappings, the model may see that the same encoding is applied to incoming data during testing or real-world application, thereby maintaining consistency in the numerical representation of categorical variables.

This encoding process may be implemented so that machine learning algorithms, which generally operate on numerical data, can interpret categorical variables effectively. Moreover, by converting categorical features like App Mnemonic, Failover Mode, and Action Type into numerical form, the model may be better equipped to analyze and incorporate these variables into its predictions, improving the overall accuracy and performance of the system.

At step 230, in some embodiments, the processor may be configured to tokenize the first set of data. Tokenization is the process of breaking down the text data into smaller components, such as words or phrases, to facilitate further analysis. For example, text data from fields such as {“action”: “RLM, T1 End”, “Tx_name”: “Infrastructure”, “valueTypeId”: “EndTime”} may be split into individual tokens like “RLM,” “T1,” “End,” “Infrastructure,” and “EndTime.” This tokenization process sees that each textual element is represented separately, allowing the model to analyze and process the individual components of the text.

At step 240, in some embodiments, the processor may then convert the tokenized data into a set of dense vector representations. This step involves mapping each token to a fixed-length vector using techniques such as Word2Vec. Word2Vec transforms the tokens into dense numerical vectors that capture semantic relationships between the words. For example, after tokenizing the text data {“action”: “RLM, T1 End”, “Tx_name”: “Infrastructure”}, a dense vector of size 5 may be generated for each token, such as [−5.163367, 9.756260, −0.814844, 1.383838, 2.408543]. These vectors, also known as embeddings, enable the model to represent the text data in a form that can be used for further machine learning tasks, such as probability prediction. The embeddings generated during this step may be stored in separate files and used later in the training and testing phases to facilitate consistency in how textual data is handled.

In some alternative embodiments, other models or techniques may be used in place of, or in addition to, Word2 Vec for text processing and vectorization. One such alternative is the TF-IDF (Term Frequency-Inverse Document Frequency) method. TF-IDF converts text into vectors by assigning a weight to each word based on its frequency in a document relative to its frequency across all documents. Unlike Word2Vec, which captures semantic relationships, TF-IDF emphasizes the significance of a word in a specific context, making it useful for tasks where frequency-based importance is critical. For example, tokenized text data such as {“action”: “RLM, T1 End”} may be vectorized using TF-IDF, producing a sparse representation where the importance of the term “RLM” is scaled according to how often it appears across all data entries.

Another alternative is GloVe (Global Vectors for Word Representation), which also generates dense vector embeddings but focuses on aggregating global word co-occurrence statistics across a dataset. GloVe may produce embeddings that are similar to Word2Vec, but with a focus on understanding broader contextual relationships in large text corpora. This method may be used in some embodiments to capture more general semantic meanings of tokens like “Infrastructure” or “EndTime,” which can help in cases where larger textual contexts provide critical insights.

In yet other embodiments, BERT (Bidirectional Encoder Representations from Transformers) or other transformer-based models may be used. BERT processes text in a bidirectional manner, meaning it considers both the left and right context of a word in a sentence, making it highly effective for capturing contextual nuances. For instance, BERT may be applied to the same data {“action”: “RLM, T1 End”, “Tx_name”: “Infrastructure”} to generate embeddings that are sensitive to the context in which these tokens appear. BERT embeddings are generally more complex and informative than traditional Word2Vec vectors, providing deep contextual understanding that may be used to improve model predictions.

Each of these alternative models offers distinct advantages depending on the nature of the data and the predictive requirements. In some embodiments, the embeddings produced by these methods, similar to Word2Vec, may be stored in separate files for use during probability prediction or other forms of model inference. Depending on the specific application and data characteristics, the appropriate text processing and embedding technique may be selected to optimize model performance.

At step 250, in some embodiments, the processor may be configured to train one or more classification models, e.g., using the set of dense vector representations. The processed data may be fed into various classification models, such as Decision Trees, a Random Forest Classifier, a Random Forest Regressor, etc. Random Forest is an ensemble learning method for classification tasks that trains multiple decision tree models and combines their predictions to make a final decision. This model may offer high accuracy and robustness against overfitting, making it suitable for certain use cases involving failover prediction.

In some embodiments, the number of decision trees in the Random Forest model may be set to a prescribed number, e.g., 100, by tuning the hyperparameters. This hyperparameter tuning may involve randomly testing parameter values and selecting the most optimal one. The model may then be trained on the processed failover data using a train/test split (e.g., 70-30, where 70% of the data may be used for training and 30% may be reserved for testing). Since the classification model is a supervised learning model, training on historical data may be necessary to enable accurate predictions. The 70% portion of the data may be used to train the model, while the remaining 30% may be used to evaluate the model's performance. If required, in some embodiments, the model may be retrained at a later stage to improve performance based on new data or adjusted parameters.

In some embodiments, the trained model may predict the success probabilities of specific step actions within a workflow, an overall success probability, the time it will take to complete the specific step actions, an average time per step, and/or an overall time. Since each workflow may consist of multiple steps, inputs such as App Mnemonic, Failover Mode, and Workflow Name may be provided to the model. The model may then calculate the success probabilities for each step in the workflow by evaluating the fraction of decision trees that predict a particular class (success or failure) for a given data point. The final workflow status, as well as the overall probability of success, may be determined by averaging the success probabilities across all steps.

In some embodiments, the accuracy of the model in predicting success/failure may be evaluated using several scoring metrics, including Accuracy Score, Precision Score, Recall Score, and/or the Confusion Matrix. These metrics may be useful for assessing the performance of the model. Accuracy may measure how often the model's predictions are correct, calculated as the ratio of correct predictions (true positives and true negatives) to the total number of predictions. Precision may measure how many of the predicted positive cases are actually positive, calculated as the ratio of true positives to the total number of positive predictions (true positives plus false positives). Recall, or sensitivity, may measure how many of the actual positive cases are correctly predicted, calculated as the ratio of true positives to the total number of actual positives (true positives plus false negatives).

In other embodiments, the model may also incorporate real-time features such as current system load or network latency, which may influence the time taken to complete failover steps. The model may be retrained periodically with updated historical data so that it remains accurate as systems and failover processes evolve.

In alternative embodiments, various other classification models may be implemented in place of (or in addition to) the Random Forest Classifier to predict failover success based on the processed data. These models offer different approaches to handling data, each with unique strengths that may be suitable for different scenarios.

For example, Support Vector Machine (SVM) classifiers may be used to separate the data points based on their features by identifying a hyperplane that maximizes the margin between the classes, such as “success” or “failure.” In some embodiments, the processor may be configured to map the data into a higher-dimensional space, where the classes are linearly separable, by using kernel functions such as linear, polynomial, or radial basis functions (RBF). The SVM model may be particularly effective when there is a clear margin of separation between classes and the dataset is not excessively large. In some embodiments, the model may be tuned through hyperparameters such as the choice of kernel and the regularization parameter (C), which controls the trade-off between achieving a low error on the training set and maximizing the margin between classes.

Another alternative that may be implemented is Gradient Boosting Machines (GBMs), which are ensemble models that build multiple decision trees sequentially. Each subsequent tree attempts to correct the errors made by the previous ones, gradually improving the model's performance. In some embodiments, the processor may apply GBM to iteratively minimize the loss function (such as log-loss for classification tasks). Hyperparameters like the learning rate, number of trees, and tree depth may be tuned to optimize performance. GBMs may be particularly useful when there are complex interactions between features, as they often perform well in structured data environments, though they require careful tuning to avoid overfitting and can be computationally intensive.

Logistic Regression is another alternative that may be suitable for binary classification tasks, such as predicting whether a failover will succeed or fail. In some embodiments, the processor may be configured to implement logistic regression by calculating the probability of a binary outcome based on a linear combination of input features. This method may be advantageous when the relationship between the features and the target is approximately linear. The model outputs probabilities, making it useful in cases where it is important to quantify the likelihood of a given outcome. Logistic regression can also be extended to handle multi-class classification through techniques like one-vs-rest or softmax regression.

In some embodiments, Neural Networks may be implemented, especially when dealing with complex data patterns where the relationships between features are non-linear. Neural networks consist of multiple layers of interconnected nodes (neurons), where each layer learns a different level of abstraction from the input data. The processor may be configured to train a neural network, e.g., by backpropagating errors through the network and updating the weights of the connections between neurons. This model can handle large datasets and capture intricate patterns within the data but may require substantial computational resources and large amounts of data to perform optimally. Hyperparameters such as the number of hidden layers, number of neurons in each layer, activation functions (e.g., ReLU, sigmoid), and learning rate may be tuned to optimize performance. Neural networks are particularly well-suited for scenarios where the dataset is complex, and the relationships between features are not easily captured by linear models.

In other embodiments, a k-Nearest Neighbors (k-NN) classifier may be used. This model classifies new data points based on the majority class of the k closest data points in the feature space, as determined by a distance metric such as Euclidean distance. This model may be suitable for smaller datasets where the relationships between data points can be effectively captured by proximity in the feature space. However, k-NN can become less efficient as the size of the dataset increases because it requires storing the entire dataset in memory and recalculating distances for each prediction.

Each of these alternative models, or combinations thereof, may be implemented depending on the specific requirements of the failover prediction task, such as the size and complexity of the dataset, the need for interpretability, and the computational resources available. The choice of model may also depend on the underlying distribution of the data and the types of relationships present between features and target outcomes. In some embodiments, multiple models may be trained and evaluated, with the most suitable model selected based on performance metrics such as accuracy, precision, recall, and F1 score.

In some embodiments, the model may be trained to predict the expected time required to complete individual steps or actions in the failover process, and/or the total expected time required, e.g., by utilizing historical failover data that includes detailed records of past events, including the time taken for each step. In some embodiments, the training process may involve collecting and preprocessing data related to past failovers, with key features such as App Mnemonic, Failover Mode, Action Type, Workflow Version, Step Status, From Datacenter, To Datacenter, System Load, and other relevant factors influencing step duration.

In some embodiments, a Random Forest Regressor may be employed to predict the time required to complete each step in the failover process, as well as the total expected time for the entire workflow. A Random Forest Regressor, like the Random Forest Classifier, is an ensemble method that builds multiple decision trees and combines their predictions. However, instead of predicting a categorical outcome (e.g., success or failure), the Random Forest Regressor may be used to predict continuous values, such as the time taken to complete a failover step.

In some embodiments, by averaging the predictions from each decision tree, the Random Forest Regressor may provide a robust estimate of the time required for each step in the workflow, whether the step is manual or automated. This approach may be particularly effective in scenarios where there is significant variability in the time required for different steps. For example, certain steps in the failover process may take longer depending on system load, network latency, or the specific datacenter configuration involved. The Random Forest Regressor may account for these factors and provide a detailed prediction of both the time for individual steps and the overall duration of the failover process.

In some embodiments, the Random Forest Regressor may be trained using historical failover data, with features such as elapsed time for previous failovers, network conditions, and datacenter performance metrics serving as inputs. The model may be trained to learn how these factors influence the time required for each step, enabling it to provide accurate predictions for future failovers. Other regression models, such as Linear Regression, Lasso, Ridge Regression, or Gradient Boosting Regressors, may also be implemented as alternatives depending on the nature of the data. Each of these models offers different strengths: for example, Linear Regression provides a simple, interpretable approach when relationships between variables are linear, while Gradient Boosting Regressors may offer higher accuracy in cases with complex interactions between system conditions.

In some embodiments, the Random Forest Regressor may be trained using a train/test split (e.g., 80-20, with 80% of the data used for training and the remaining 20% reserved for testing). Since the model is supervised, it may be trained on historical failover data, learning how factors such as system conditions, step type, and historical elapsed times influence the duration of failover steps. The remaining 20% of the data may be used to evaluate the model's performance and adjust its parameters as needed to improve accuracy. If necessary, the model may be retrained on new data or adjusted to optimize performance.

To evaluate the accuracy of the regression model's predictions, various scoring metrics may be employed, including Mean Squared Error (MSE), Root Mean Squared Error (RMSE), Mean Absolute Error (MAE), and R-squared (Coefficient of Determination). These metrics are specifically suited for regression tasks, providing different insights into the accuracy and reliability of the model's predictions. MSE quantifies the average squared difference between the predicted and actual values, offering a measure of the expected squared error or loss. RMSE, as the square root of MSE, provides an interpretable sense of how far the predicted values are from the actual outcomes. MAE calculates the average absolute difference between predicted and actual values, treating all errors equally without considering their direction. R-squared measures the proportion of variance in the dependent variable (such as step completion time) that can be explained by the independent variables, providing a measure of how well the model fits the data. These metrics, unlike classification metrics such as accuracy, precision, and recall, are specifically designed for continuous predictions and provide a comprehensive assessment of the model's performance in predicting failover step durations.

In some embodiments, one or more or a variety of regression models may be used for this training process, as the goal is to predict continuous values (i.e., time durations). A model such as Random Forest Regression, Gradient Boosting Regression, or Linear Regression may be selected depending on the complexity of the relationships between the features. For example, Random Forest Regression can handle non-linear relationships and interactions between features by constructing multiple decision trees and averaging their predictions, making it suitable for more complex datasets. In contrast, Linear Regression may be used in cases where the relationship between features and the time to complete a step is approximately linear.

To prepare the data for training, the processor may first preprocess the historical failover data, as described herein. This preprocessing step may include, for example, handling missing values, normalizing numerical data, and converting categorical features (e.g., App Mnemonic, Failover Mode) into numerical representations through methods like label encoding. The data may then be split into training and validation sets, with the training set used to train the model and the validation set reserved for evaluating the model's performance.

During the training phase, the model may iteratively adjust its internal parameters to minimize the error in predicting step completion times. In some embodiments, hyperparameter tuning may be performed to optimize model performance, for instance, by adjusting the number of trees in a Random Forest model, the learning rate in a Gradient Boosting model, or the regularization parameters in a Linear Regression model. Cross-validation techniques may also be applied so that the model generalizes well to unseen data and does not overfit the training set.

The trained model may then be evaluated/tested using appropriate performance metrics, such as mean absolute error (MAE), root mean squared error (RMSE), or R-squared (R²), which quantify the accuracy of the model's predictions in comparison to the actual time taken for steps in the validation data. If the performance is insufficient, the model may be further refined by retraining it on additional data or adjusting the feature selection process to include more relevant attributes.

In some embodiments, method 200 continues, during a prediction stage, at step 260, when the processor may be configured to receive a request to predict a failover outcome for a given failover process. This request may originate from a user interacting with a failover readiness predictor application (failover readiness predictor application 140) on a user device (e.g., user device 150). In some embodiments, the user may initiate the request through an interface element, such as a button or dropdown menu. Upon receiving the request, the processor may retrieve the relevant input data (e.g., from a failover execution platform, such as failover execution platform 160, or from other elements of system 100) and prepare to evaluate the potential outcomes of the failover process.

At step 270, in some embodiments, the processor may be configured to assess the status of concurrent system conditions in real-time or near real-time, as part of the prediction process for a failover outcome. In some embodiments, this step may be initiated when the user interacts with failover readiness predictor application 140, as described herein typically by selecting a “Predict” button on the user interface. The user may see this button when preparing to execute a failover process, and upon clicking it, a payload (e.g., in JSON format) may be sent to the backend service, requesting the necessary data for prediction. In other embodiments, this may be an automated process, occurring regularly (e.g., on a schedule), periodically (e.g., daily, monthly, etc.), or may be triggered by certain metrics or events.

In some embodiments, the payload may include parameters such as App Mnemonic, Failover Mode, From Datacenter, To Datacenter, and/or other relevant details. Once the processor receives this request, it may be configured to fetch the necessary data from a connected database, e.g., database(s) 170, which may contain both historical failover data and live system information. In conjunction with retrieving historical data, in some embodiments, the processor may simultaneously gather real-time operational data from various system components, such as system load, network latency, current failover configurations, and performance metrics of the datacenters involved in the failover process, and/or from outside source(s) 180.

For example, internal and/or external monitoring tools may provide up-to-the-minute metrics on network bandwidth, CPU utilization, or storage capacity at each datacenter, while application logs can capture recent events or errors that may affect the failover's success. Network health metrics, such as latency between primary and backup datacenters, may also be critical for determining the current risk of failure during a failover. By incorporating this real-Attorney time system information, the processor may help the prediction model have an accurate and up-to-date understanding of the environment in which the failover will occur.

In some embodiments, once the processor retrieves this data, it may be preprocessed (as described herein with respect preprocessing the historical data) before it is passed to the prediction model. In some embodiments, this preprocessing may involve two primary steps: label encoding and vectorization, as described herein.

After the label encoding and vectorization steps are completed, in some embodiments, the resulting vectors (representing both historical data and real-time system conditions) are ready to be passed to the next step—where the trained model will use them to generate a prediction regarding the failover outcome.

By having both historical failover data and current system conditions preprocessed and transformed into vectors, in some embodiments, the processor enables the trained model to effectively assess the input data and provide accurate predictions in subsequent steps. This combination of historical and real-time data processing helps the prediction to reflect the current state of the system while drawing on patterns learned from past failover events.

At step 280, in some embodiments, the processor may be configured to predict at least one of the success probability of the failover process and/or the expected time for one or more steps in the failover process. These predictions may be based on the classification model or models previously trained on historical failover data, as well as the real-time system conditions assessed in step 270. In some embodiments, the vectors generated during the assessment may be passed to two different models, e.g., a Random Forest Classifier to predict the success or failure of each individual workflow step and a Random Forest Regressor to predict the time required to complete each step.

In some embodiments, the vectors may be provided to the Random Forest Classifier, which evaluates each step in the workflow based on factors such as real-time system load, step type (manual or automated), network conditions, and historical outcomes. The classifier, which was previously trained on historical data, processes each step to predict whether it is likely to succeed or fail. These individual step predictions may then be aggregated to predict the overall workflow status, enabling the system to assess whether the entire failover process will likely succeed or encounter failures.

Additionally or alternatively, in some embodiments, the vectors may be passed to the Random Forest Regressor, a model chosen for its effectiveness in predicting continuous variables, such as the expected time to complete each step and/or a total expected time. The Random Forest Regressor may provide accurate results due to its ensemble approach, which combines the predictions of multiple decision trees to improve overall accuracy. This method is particularly advantageous for regression tasks where the goal is to predict step durations, as it reduces the risk of overfitting and increases the robustness of predictions.

After the predictions are generated by the Random Forest Classifier and/or the Random Forest Regressor, in some embodiments, the results are compiled and sent to the user device for display. In some embodiments, the user may be presented with the overall workflow status, indicating the likelihood of success or failure for the entire failover process. In some embodiments, the user may be presented with a detailed breakdown of the predicted time required for each step in the workflow and/or a total predicted time. In certain embodiments, the user may also see visual representations of the success probability and time estimates, allowing them to quickly assess the predicted outcomes and make informed decisions about whether to proceed with the failover or make adjustments based on the model's predictions. By leveraging both classification and regression models, the processor provides a comprehensive set of predictions that inform both the likelihood of success and the expected duration of the failover process, enabling efficient decision-making and optimization of failover strategies.

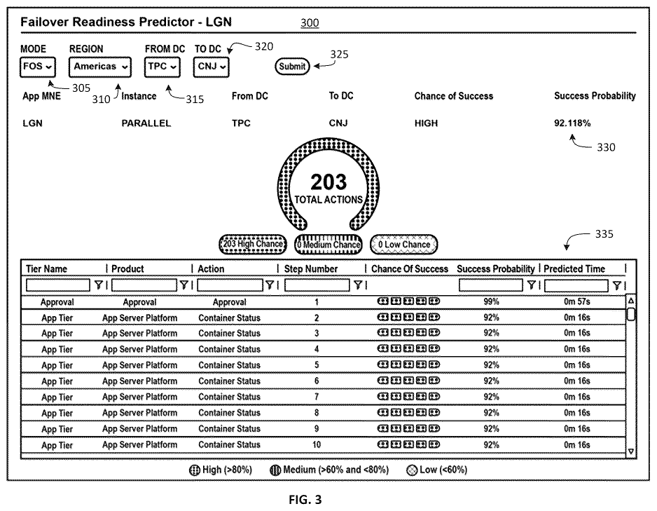

Turning briefly to FIG. 3, a user interface 300 of failover readiness predictor application 140 is shown according to at least one embodiment. In some embodiments, user interface 300 may enable a user to adjust various settings and/or parameters, and execute a failover prediction of success probability, as well as a failover prediction of expected time. In some embodiments, user interface 300 may include one or more dropdown menus and/or other interactive elements for selecting various parameters and executing a failover prediction. For example, in various embodiments, one or more of the following parameters may be provided:
Mode 305: represents a failover type, e.g., failover to other location as part of on-demand failover and stay or as part of disaster recovery. Other examples may include active-passive (or standby), active-active, hot failover, warm failover, cold failover, synchronous-commit with automatic failover, and asynchronous-commit, with variations depending on the specific system or application, often including options for manual failover and forced failover.
Region 310: represents selectable workflows for different regions, for example, Americas, Asia, EMEA, etc.
FROM DC 315: represents a location (e.g., of a primary data center) from where the application is failing.
TO DC 320: represents a location (e.g., of a backup data center) to where the application is failing over.

Those of skill in the art will understand that, in various embodiments, additional and/or other parameters may be offered for selection, as well as a submit button 325. Upon selection of the various parameters, in some embodiments, a user may execute the failover readiness prediction, as described in detail herein, by selecting the submit button 325.

In some embodiments, user interface 300 may include or otherwise provide various results of the presentation, including, e.g., a success probability 330 of the failover process, and/or an expected (predicted) time 335 for at least one of a plurality of steps in the failover process, e.g., based at least in part on the classification model and the status of the concurrent system conditions, as described in detail herein.

Embodiments described herein provide significant technical advancements over legacy failover prediction systems by addressing critical technical problems such as system downtime, inadequate failover prediction accuracy, and the inability to respond swiftly to failures in business-critical environments. Legacy systems are often reactive and unable to proactively predict and manage failovers, leading to extended service interruptions, data loss, and inefficient system recovery. The technical solutions provided by these embodiments optimize system resilience, enhance failover readiness, and improve recovery readiness through advanced data processing techniques, machine learning models, and real-time system assessments.

One example technical problem solved by these embodiments is the inability of legacy systems to effectively prepare for disruptions and maintain service availability. Embodiments of the advanced failover readiness predictor address this issue by employing machine learning models, such as Random Forest Classifiers and Regressors, that analyze historical data combined with real-time system conditions to predict the likelihood of successful failovers and the time required for each step in the process. By providing accurate, real-time predictions of potential failures and step durations, the system enables proactive decision-making, reducing the risk of unplanned downtime and maintaining service availability, even during failure scenarios.

Another example technical issue in legacy systems is the lack of infrastructure resilience due to insufficient recovery readiness measures. These embodiments offer a technical solution by continuously monitoring and assessing real-time operational data-such as system load, network latency, and datacenter performance-combined with historical failover data. This real-time data is preprocessed using label encoding and vectorization techniques, making it compatible with machine learning models. The system then uses these models to predict the success probability of the failover process and/or the expected time for each individual step, allowing for faster and more accurate responses to failures. This enhanced failover readiness fortifies the infrastructure, providing a more robust system that can respond to failures with minimal delays.

A further example technical problem is the lack of automated and predictive approaches in legacy systems, which results in slow and inefficient failover processes. The embodiments described herein solve this by implementing automated failover prediction and management through a combination of classification and regression models. These models are trained on large datasets, to learn from past failover events and continuously improve prediction accuracy. This allows the system to anticipate potential disruptions before they occur and to provide technical solutions that minimize downtime, optimize resource allocation, and facilitate business continuity.

Moreover, the technical solutions offered by these embodiments include reducing the likelihood of data loss and service interruptions through a proactive, machine-learning-driven recovery readiness framework. The system is capable of predicting not only whether a failover will succeed but also how long each step of the process will take, based on real-time and historical data. This granular level of prediction enables the system to optimize the failover process, such that critical steps are completed in the most efficient manner possible, while minimizing the risk of service degradation or data loss during the failover.

These technical improvements represent a significant enhancement over legacy failover systems, offering a more reliable, efficient, and predictive approach to managing failovers and providing business continuity.

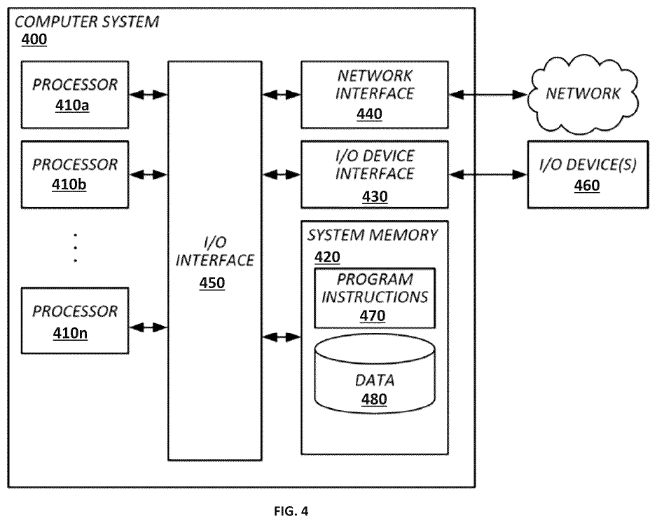

FIG. 4 is a schematic of a computing system, in accordance with some embodiments of the present disclosure. FIG. 4 is a diagram that illustrates an exemplary computing system 400 in accordance with embodiments of the present disclosure. Various portions of systems and methods described herein, may include or be executed on one or more computing systems similar to computing system 400. Further, processes and modules described herein may be executed by one or more processing systems similar to that of computing system 400.

Computing system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computing system 400 may be a uni-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 400 may include a plurality of computing devices (e.g., distributed computing systems) to implement various processing functions.

I/O device interface 430 may provide an interface for connection of one or more I/O devices 460 to computing system 400. I/O devices may include devices that receive input (e.g., from a user) or output information (e.g., to a user). I/O devices 460 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computing system 400 through a wired or wireless connection. I/O devices 460 may be connected to computing system 400 from a remote location. I/O devices 460 located on remote computing system, for example, may be connected to computing system 400 via a network and network interface 440.

Network interface 440 may include a network adapter that provides for connection of computing system 400 to a network. Network interface 440 may facilitate data exchange between computing system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Program instructions 470 may be executable by a processor (e.g., one or more of processors 410a-410n) to implement one or more embodiments of the present techniques. Instructions 470 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 400 or multiple computing systems 400 configured to host different portions or instances of embodiments. Multiple computing systems 400 may provide for parallel or sequential processing/execution of one or more portions of the techniques described herein.

Those skilled in the art will appreciate that computing system 400 is merely illustrative and is not intended to limit the scope of the techniques described herein. Computing system 400 may include any combination of devices or software that may perform or otherwise provide for the performance of the techniques described herein. For example, computing system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 400 may be transmitted to computing system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 400 may be transmitted to computing system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, the applicant has grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B may include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A method for providing failover readiness prediction, comprising:
during a training stage:
selecting, by a processor, a first set of data from a database of historical failover data based at least in part on feature importance within the historical failover data;
label encoding, by the processor, the first set of data;
tokenizing, by the processor, the first set of data;
converting, by the processor, the first set of data into a set of dense vector representations; and
training, by the processor, a classification model using the set of dense vector representations;
during a predication stage:
receiving, by the processor, a request to predict a failover outcome for a given failover process;
assessing, by the processor, a status of concurrent system conditions; and
predicting, by the processor, at least one of a success probability of the failover process, or an expected time for at least one of a plurality of steps in the failover process, based at least in part on the classification model and the status of the concurrent system conditions.

2. The method as in claim 1, wherein the historical failover data comprises data relating to failed failovers and successful failovers.

3. The method as in claim 2, wherein the selected first set of data comprises balanced data reflecting both the failed failovers and the successful failovers.

4. The method as in claim 1, wherein the feature importance is determined by implementing at least one of a correlation matrix or a heat map.

5. The method as in claim 1, wherein the classification model is a random forest classifier model.

6. The method as in claim 1, wherein predicting the success probability of the failover process comprises predicting one or more of the success probability of at least one specific step action of a plurality of step actions in the failover process, or an overall success probability of the failover process.

7. The method as in claim 1, further comprising predicting at least one of an average time per step of the plurality of steps in the failover process or an overall time for the failover process.

8. A system for providing failover readiness prediction, comprising:
a computer system comprising one or more processors programmed with computer program instructions which, when executed, cause the computer system to:
during a training stage:
select a first set of data from a database of historical failover data based at least in part on feature importance within the historical failover data;
label encode the first set of data;
tokenize the first set of data;
convert the first set of data into a set of dense vector representations; and
train a classification model using the set of dense vector representations;
during a predication stage:
receive a request to predict a failover outcome for a given failover process;
assess a status of concurrent system conditions; and
predict at least one of a success probability of the failover process, or an expected time for at least one of a plurality of steps in the failover process, based at least in part on the classification model and the status of the concurrent system conditions.

9. The system as in claim 8, wherein the historical failover data comprises data relating to failed failovers and successful failovers.

10. The system as in claim 9, wherein the selected first set of data comprises balanced data reflecting both the failed failovers and the successful failovers.

11. The system as in claim 8, wherein the feature importance is determined by implementing at least one of a correlation matrix or a heat map.

12. The system as in claim 8, wherein the classification model is a random forest classifier model.

13. The system as in claim 8, wherein predicting the success probability of the failover process comprises predicting one or more of the success probability of at least one specific step action of a plurality of step actions in the failover process, or an overall success probability of the failover process.

14. The system as in claim 8, further configured to predict at least one of an average time per step of the plurality of steps in the failover process or an overall time for the failover process.

15. A non-transitory computer-readable media comprising instructions that, when executed by one or more processors, cause operations comprising:
during a training stage:
selecting a first set of data from a database of historical failover data based at least in part on feature importance within the historical failover data;
label encoding the first set of data;
tokenizing the first set of data;
converting the first set of data into a set of dense vector representations; and
training a classification model using the set of dense vector representations;
during a predication stage:
receiving a request to predict a failover outcome for a given failover process;
assessing a status of concurrent system conditions; and
predicting at least one of a success probability of the failover process, or an expected time for at least one of a plurality of steps in the failover process, based at least in part on the classification model and the status of the concurrent system conditions.

16. The non-transitory computer-readable media as in claim 15, wherein the historical failover data comprises data relating to failed failovers and successful failovers.

17. The non-transitory computer-readable media as in claim 16, wherein the selected first set of data comprises balanced data reflecting both the failed failovers and the successful failovers.

18. The non-transitory computer-readable media as in claim 15, wherein the feature importance is determined by implementing at least one of a correlation matrix or a heat map.

19. The non-transitory computer-readable media as in claim 15, wherein the classification model is a random forest classifier model.

20. The non-transitory computer-readable media as in claim 15, wherein predicting the success probability of the failover process comprises predicting one or more of the success probability of at least one specific step action of a plurality of step actions in the failover process, or an overall success probability of the failover process; and
further comprising predicting at least one of an average time per step of the plurality of steps in the failover process or an overall time for the failover process.
